(19) United States
(12) Patent Application Publication
(10) Pub. No.: US 2021/0185997 A1
(43) Pub. Date: Jun. 24, 2021

(54) Disposable Snail Trap Apparatus

(71) Applicant: Kristi Carter, Danville, CA (US)

(72) Inventor: Kristi Carter, Danville, CA (US)

(21) Appl. No.: 16/720,994

(22) Filed: Dec. 19, 2019

(51) Int. Cl. A01M 23/02

(52) U.S. Cl. CPC A01M 23/02

(57) ABSTRACT

A disposable snail trap apparatus for removing snails from gardens includes a trap body. The trap body comprises a cylindrical sidewall having an open bottom edge and a hemispherical roof defining a trap inside. The sidewall has a plurality of door slots extending through to the trap inside. Each door slot extends from the bottom edge towards the roof. An interior surface of the trap body is textured. A plurality of overhangs is coupled to the trap body. The plurality of overhangs is coupled to the sidewall above the plurality of door slots to cast shadows and draw snails into the trap. The snails then climb the interior surface of the trap body and the apparatus may be removed and disposed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to snail traps and more particularly pertains to a new snail trap for removing snails from gardens.

### BRIEF SUMMARY OF THE INVENTION

An embodiment of the disclosure meets the needs presented above by generally comprising a trap body. The trap body comprises a cylindrical sidewall having an open bottom edge and a hemispherical roof defining a trap inside. The sidewall has a plurality of door slots extending through to the trap inside. Each door slot extends from the bottom edge towards the roof. An interior surface of the trap body is textured. A plurality of overhangs is coupled to the trap body. The plurality of overhangs is coupled to the sidewall above the plurality of door slots.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a disposable snail trap apparatus according to an embodiment of the disclosure.

FIG. 2 is a front elevation view of an embodiment of the disclosure.

FIG. 3 is a bottom plan view of an embodiment of the disclosure.

FIG. 4 is a rear elevation view of an embodiment of the disclosure.

FIG. 5 is an in-use view of an embodiment of the disclosure.

### DETAILED DESCRIPTION OF THE INVENTION

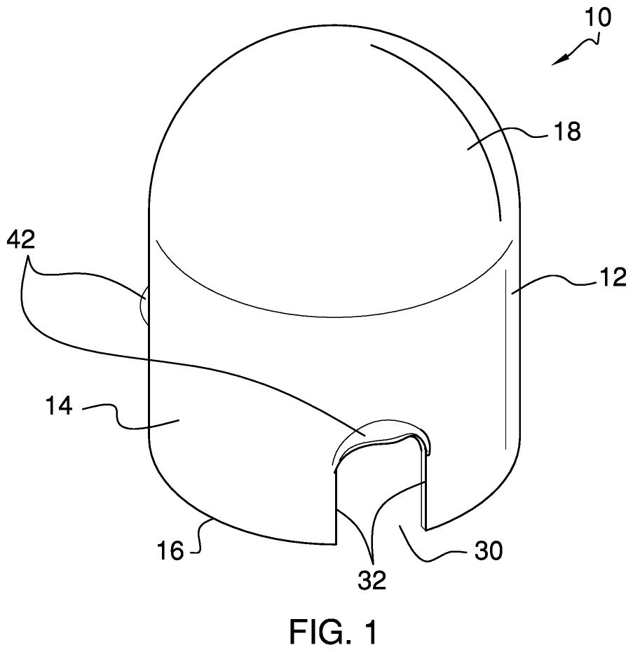

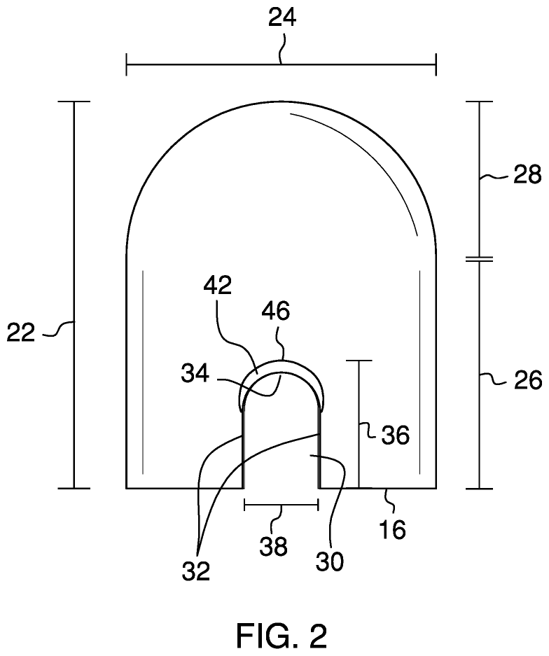

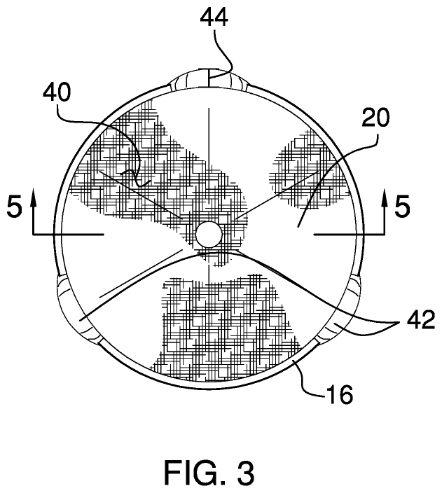

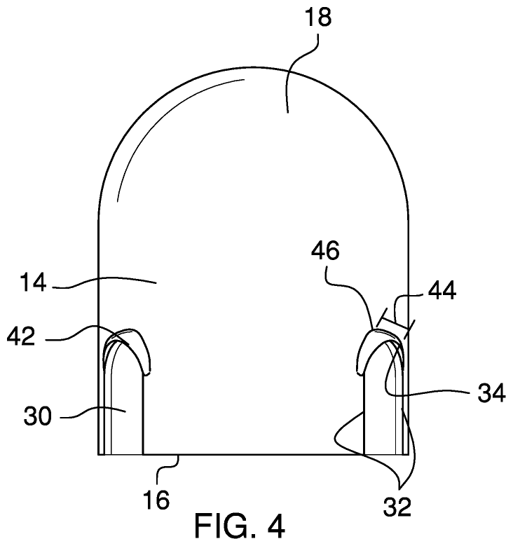

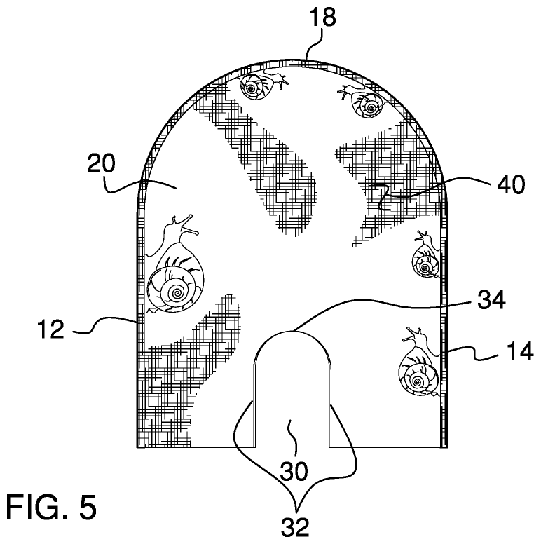

With reference now to the drawings, and in particular to FIGS. 1 through 5 thereof, a new snail trap embodying the principles and concepts of an embodiment of the disclosure and generally designated by the reference numeral 10 will be described.

As best illustrated in FIGS. 1 through 5, the disposable snail trap apparatus 10 generally comprises a trap body 12. The trap body 12 comprises a cylindrical sidewall 14 having an open bottom edge 16 and a hemispherical roof 18 defining a trap inside 20. A body height 22 of the trap body 12 is 25% greater than a body diameter 24 of the trap body 12. A wall height 26 of the side wall 14 is 50% greater than a roof height 28 of the roof 18. Ideally the bod height 22 is ten inches, the body diameter is eight inches, the wall height is six inches and the roof height is four inches. The sidewall 14 has a plurality of door slots 30 extending through to the trap inside 20. Each door slot 30 has a pair of vertical edges 32 extending from the bottom edge 16 towards the roof 18 and a semicircular top edge 34. Each of the door slots 30 has a door height 36 50% greater than a door width 38. The door width 38 is 25% of the body diameter 24 and is thus ideally two inches with the door height 36 is three inches. The plurality of door slots 30 may be three door slots 30 each spaced 120° apart around the sidewall 14. The trap body 12 may be molded cellulose fiber and sufficiently thin to be crumpled or folded. The trap body 12 creates a shaded refuge to draw snails through the door slots 30. An interior surface 40 of the trap body is textured so the snails will climb the sidewall 14 and the roof 18. A plurality of overhangs 42 is coupled to the trap body 12. The plurality of overhangs 42 is coupled to the sidewall 14 along the top edge 34 of the plurality of door slots to create a shadow outside of the trap body 12 and further entice the snails. An overhang width 44 of each overhang 42 may be greatest at an apex 46 of each door slot 30 and progressively diminishes as the overhang 42 approaches the pair of vertical edges 32.

In use, the apparatus 10 is placed on a lawn or in a garden. Once the interior surface 40 is sufficiently covered with snails, the apparatus 10 is removed, folded, and placed in the trash.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A disposable snail trap apparatus comprising:
a trap body, the trap body comprising a cylindrical sidewall having an open bottom edge and a hemispherical roof defining a trap inside, the sidewall having a plurality of door slots extending through to the trap inside, each door slot extending from the bottom edge towards the roof, an interior surface of the trap body being textured; and
a plurality of overhangs coupled to the trap body, the plurality of overhangs being coupled to the sidewall above the plurality of door slots.

2. The disposable snail trap apparatus of claim 1 further comprising a body height of the trap body being 25% greater than a body diameter of the trap body.

3. The disposable snail trap apparatus of claim 2 further comprising a wall height of the side wall being 50% greater than a roof height of the roof.

4. The disposable snail trap apparatus of claim 1 further comprising each of the door slots having a pair of vertical edges and a semicircular top edge, the plurality of overhangs being coupled to the top edge.

5. The disposable snail trap apparatus of claim 1 further comprising each of the door slots having a door height 50% greater than a door width.

6. The disposable snail trap apparatus of claim 5 further comprising the door width being 25% of a body diameter of the trap body.

7. The disposable snail trap apparatus of claim 1 further comprising the trap body being molded cellulose fiber.

8. The disposable snail trap apparatus of claim 1 further comprising the plurality of door slots being evenly spaced around the sidewall.

9. The disposable snail trap apparatus of claim 8 further comprising the plurality of door slots being three door slots each spaced 120° apart.

10. A disposable snail trap apparatus comprising:
a trap body, the trap body comprising a cylindrical sidewall having an open bottom edge and a hemispherical roof defining a trap inside, a body height of the trap body being 25% greater than a body diameter of the trap body, a wall height of the side wall being 50% greater than a roof height of the roof, the sidewall having a plurality of door slots extending through to the trap inside, each door slot having a pair of vertical edges extending from the bottom edge towards the roof and a semicircular top edge, each of the door slots having a door height 50% greater than a door width, the door width being 25% of the body diameter, the plurality of door slots being three door slots each spaced 120° apart around the sidewall, the trap body being molded cellulose fiber and having an interior surface of the trap body being textured; and
a plurality of overhangs coupled to the trap body, the plurality of overhangs being coupled to the sidewall along the top edge of the plurality of door slots.
